(19) United States
(12) Patent Application Publication
(10) Pub. No.: US 2026/0307611 A1
(43) Pub. Date: Oct. 8, 2026

(54) BATTERY POWER BUDGET ALLOCATION FOR ECMS OF A VEHICLE IMPLEMENTED IN AN IOT ECOSYSTEM

(71) Applicant: GM GLOBAL TECHNOLOGY OPERATIONS LLC, Detroit, MI (US)

(72) Inventors: Ahmed F. Al Alawy, Canton, MI (US); Venkata Naga Siva Vikas VEMURI, Farmington Hills, MI (US); Mustafa Hamada CHMEISEH, Shelby Township, MI (US); John SERGAKIS, Bloomfield Hills, MI (US)

(21) Appl. No.: 19/169,198

(22) Filed: Apr. 3, 2025

(51) Int. Cl. B60R 16/033; B60R 16/023; H01M 10/44

(52) U.S. Cl. CPC B60R 16/033; B60R 16/0238; H01M 10/44; H01M 2220/20

(57) ABSTRACT

An Internet-of-things (IoT) ecosystem includes: electronic control modules (ECMs) implemented in a vehicle and configured to perform dedicated functions of features of the IoT ecosystem, where the IoT ecosystem includes IoT devices; and an IoT controller configured to obtain contextual data and, based on the contextual data, assign at least one battery power budget for the ECMs and corresponding ones of the dedicated functions. At least a portion of the contextual data is received from the IoT devices and the ECMs. The ECMs are configured to implement the dedicated functions based on the at least one battery power budget.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to Internet of things (IoT) ecosystems and vehicle and battery power budget allocation systems.

A home (or residential) ecosystem is an interconnected network of smart devices and can include a central hub and multiple IoT devices that wirelessly communicate with the central hub. Examples of a home ecosystem are Amazon Alexa®, Apple HomeKit®, and Google Home®. The IoT devices can include smart speakers, appliances, smart electrical plugs, smart lights, smart switches, etc. A user is able to control the status of the IoT devices via the central hub or via an ecosystem application executed on, for example, a mobile phone.

### SUMMARY

An Internet-of-things (IoT) ecosystem is disclosed and includes: electronic control modules (ECMs) implemented in a vehicle and configured to perform dedicated functions of features of the IoT ecosystem, where the IoT ecosystem includes IoT devices; and an IoT controller configured to obtain contextual data and, based on the contextual data, assign at least one battery power budget for the ECMs and corresponding ones of the dedicated functions. At least a portion of the contextual data is received from the IoT devices and the ECMs. The ECMs are configured to implement the dedicated functions based on the at least one battery power budget.

In other features, the IoT controller is implemented in the vehicle, a portable access device, a charging station, a central hub of a building, or in an IoT device separate from the vehicle.

In other features, the IoT controller is configured to recommend a battery power budget for one of the ECMs, and receive from the one of the ECMs an accept or deny response for the recommended battery power budget from the IoT controller.

In other features, the one of the ECMs is configured to at least one of i) request additional battery power than recommended in the recommended battery power budget for the one of the ECMs, and ii) negotiate the battery power budget for the one of the ECMs with the other ones of the ECMs.

In other features, the IoT controller is configured to assign a battery power budget to one of the ECMs. The ECMs are configured to determine whether to accept or change the assigned battery power budget for the one of the ECMs.

In other features, the IoT controller is configured to implement battery power budget process including assigning an overall battery power budget for the ECMs of the vehicle and providing the overall battery power budget to one of the ECMs. The one of the ECMs is configured to determine battery power budgets for the remaining ones of the ECMs based on the overall battery power budget.

In other features, the IoT controller is configured to: monitor for change of events with the ECMs; determine whether the change of events warrant at least one of i) an updated overall battery power budget and ii) adjustment of one or more battery power budgets of the ECMs; collect updated contextual data; and in response to determining the updated overall battery power budget is warranted or adjustment of the one or more battery power budgets is warranted, collect updated contextual data, and based on the updated contextual data, update at least one of the updated overall battery power budget and the one or more battery power budgets.

In other features, the IoT controller or the ECMs is configured to: monitor attributes of the dedicated functions for determining key performance indicators (KPIs); calculate the KPIs for each of the attributes; determine whether a KPI score is equal to a threshold or is a detected anomaly; in response to the KPI score being equal to the threshold or being a detected anomaly, store the KPI score in a KPI confidence rating matrix; in response to the KPI score not being equal to the threshold and not being an anomaly, determines whether to adjust at least one battery power budget for one or more of the features and the dedicated functions; and in response to determining to make the adjustment, adjust the at least one battery power budget.

In other features, the IoT controller or the ECMs is configured to: monitor key performance indicator (KPI) anomalies of attributes of the dedicated functions; calculate anomaly scores; determine if one of the anomaly scores is greater than a threshold; and if greater than the threshold, at least one of i) cease performing at least one of the feature and the function associated with the one of the anomaly scores greater than a threshold, and ii) disengage one of the ECMs that is associated with the one of the anomaly scores greater than a threshold.

In other features, the IoT controller or the ECMs is configured to: queue the features based on an activity schedule; map the features to the ECMs based on the at least one battery power budget; determine whether multiple features are requested; if multiple features are requested, pre-commission assessment of features to ecosystem resources; and run a conflict procedure to determine or of execution of the features requested.

In other features, at least some of the IoT devices are located in or attached to a building.

In other features, a method of allocating battery power for ECMs of a vehicle in an IoT ecosystem. The method includes: obtaining contextual data at an IoT controller and, based on the contextual data, assigning at least one battery power budget for the ECMs and corresponding ones of dedicated functions, where the dedicated functions are of features of the IoT ecosystem, and where at least a portion of the contextual data is received from IoT devices in the IoT ecosystem and the ECMs; and implementing the dedicated functions via the ECMs based on the at least one battery power budget.

In other features, the IoT controller is implemented in the vehicle, a portable access device, a charging station, a central hub of a building, or in an IoT device separate from the vehicle.

In other features, the method further includes, via the IoT controller, recommending a battery power budget for one of the ECMs, and receiving from the one of the ECMs an accept or deny response for the recommended battery power budget from the IoT controller.

In other features, the method further includes: via the IoT controller, assigning a battery power budget to one of the ECMs; and via the ECMs, determining whether to accept or change the assigned battery power budget for the one of the ECMs.

In other features, the method further includes: implementing battery power budget process via the IoT controller including assigning an overall battery power budget for the vehicle and providing the overall battery power budget to one of the ECMs; and determining, via the one of the ECMs, battery power budgets for the remaining ones of the ECMs based on the overall battery power budget.

In other features, the method further includes: monitoring for change of events with the ECMs; determining whether the change of events warrant at least one of i) an updated overall battery power budget and ii) adjustment of one or more battery power budgets of the ECMs; collecting updated contextual data; in response to determining the updated overall battery power budget is warranted or adjustment of the one or more battery power budgets is warranted, collecting updated contextual data; and based on the updated contextual data, updating at least one of the updated overall battery power budget and the one or more battery power budgets.

In other features, the method further includes: monitoring attributes of the dedicated functions for determining key performance indicators (KPIs); calculating the KPIs for each of the attributes; determining whether a KPI score is equal to a threshold or is a detected anomaly; in response to the KPI score being equal to the threshold or being a detected anomaly, storing the KPI score in a KPI confidence rating matrix; in response to the KPI score not being equal to the threshold and not being an anomaly, determining whether to adjust at least one battery power budget for one or more of the features and the dedicated functions; and in response to determining to make the adjustment, adjusting the at least one battery power budget.

In other features, further including: monitoring key performance indicator (KPI) anomalies of attributes of the dedicated functions; calculating anomaly scores; determining if one of the anomaly scores is greater than a threshold; and if greater than the threshold, at least one of i) ceasing to perform at least one of the feature and the function associated with the one of the anomaly scores greater than a threshold, and ii) disengaging one of the ECMs that is associated with the one of the anomaly scores greater than a threshold.

In other features, the method further includes: queueing the features based on an activity schedule; mapping the features to the ECMs based on the at least one battery power budget; determining whether multiple features are requested; if multiple features are requested, pre-commissioning assessment of features to ecosystem resources; and running a conflict procedure to determine or of execution of the features requested.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example IoT ecosystem including a vehicle and an IoT controller in accordance with the present disclosure;

FIG. 2 is a functional block diagram of a portion of an IoT ecosystem including an IoT controller implemented separate from a vehicle and the vehicle including a master electronic control module (ECM) and secondary ECMs in accordance with an embodiment of the present disclosure;

FIG. 3 is a functional block diagram of a portion of an IoT ecosystem including an IoT controller separate from a vehicle and the vehicle including multiple ECMs in accordance with an embodiment of the present disclosure;

FIG. 4 is a functional block diagram of a portion of an IoT ecosystem including an example vehicle with an IoT controller and multiple ECMs in accordance with an embodiment of the present disclosure;

FIG. 5 is a functional block diagram of an example vehicle including an IoT controller or master ECM and multiple other ECMs in accordance with an embodiment of the present disclosure;

FIGS. 6A and 6B (collectively FIG. 6) illustrate a centralized method of battery power budget allocation in accordance with an embodiment of the present disclosure;

FIG. 7 illustrates a decentralized method of battery power budget allocation in accordance with an embodiment of the present disclosure;

FIG. 8 illustrates a decentralized method for disengaging an ECM and/or one or more features and/or corresponding functions in accordance with an embodiment of the present disclosure; and

FIG. 9 illustrates a decentralized method for mapping features to an ECM, pre-commissioning assessment of features, and addressing conflicts between features and/or ECMs in accordance with an embodiment of the present disclosure.

In the drawings, reference numbers may be reused to identify similar and/or identical elements.

### DETAILED DESCRIPTION

A vehicle can be part of a home IoT ecosystem (or smart home ecosystem) and/or other IoT ecosystem (e.g., an IoT ecosystem at a place of business, an airport, etc.). A vehicle can play vital role in a connected home experience and can be one of the most frequently used smart devices in individuals' daily lives. Features that require a vehicle to be connected can be utilized by both home IoT devices and a vehicle. As a few examples, the features can include an individual's calendar of scheduled events, emergency calling and tracking features, security monitoring and alerting features, etc. The home IoT devices and the vehicle benefit from the vehicle being connected to share feature information and/or to perform feature related functions. When a vehicle is at home, parked and OFF, the vehicle can be limited in its ability to remain connected with a home ecosystem and share feature information and perform feature related functions. This can be due to the number of ECMs and corresponding vehicle systems involved and/or the state of charge of low and high voltage batteries and/or battery packs within the vehicle.

The examples set forth herein include systems and methods for managing battery power consumption of ECMs and corresponding vehicle systems during an OFF state of a vehicle. When the vehicle is OFF, a powertrain will not engage, a vehicle ignition (if equipped with an ignition) is OFF, vehicle motor(s) are powered down, infotainment system is OFF, and exterior and interior lighting is typically OFF. While in the OFF state, the vehicle operates in a connectivity mode and performs battery management operations. By remaining in a connectivity mode, time to wake up and reestablish connections is avoided and thus there is less wait time to perform operations.

When in the connectivity mode, one or more communication links have been established between i) one or more ECMs, telematics module, and/or an IoT controller of the vehicle and ii) a cloud-based server of, for example, a server of a back office. The back office may be a back office of a service provider (e.g., a manufacturer of the vehicle). The back office may also be in communication with a central hub and/or IoT controller of a building IoT ecosystem such as a home or office IoT ecosystem an airport IoT ecosystem, or other facility IoT ecosystem.

The managing of battery power consumption includes the managing of battery power consumption limits of each ECM of the vehicle during the OFF state. A vehicle can have tens of ECMs (e.g., 50-100 ECMs). Each ECM may be implemented as part a corresponding vehicle system, such as a motor control system, an engine control system, a transmission control system, an infotainment system, a telematic system, a collision avoidance system, a braking system, a steering system, etc. and control operations performed by the corresponding vehicle system.

The examples herein include the use of an IoT controller, which may be internal to or external to a vehicle. The IoT controller collects contextual data and based on the contextual data allocates an amount (or a respective percentage) of a battery power budget to each ECM. Contextual data refers to a specific data set used in a given context of an algorithm. As an example, contextual data may refer to i) data indicative of whether a vehicle is plugged into a charger to charge batteries of the vehicle, ii) data indicative of access availability to an electronic calendar, iii) data indicative of access availability to a user's location such as via a cellular device, iv) data indicative of a scheduled trip of the vehicle, v) time until an event occurs, such as a dinner event, vi) vacation and/or travel dates, etc.

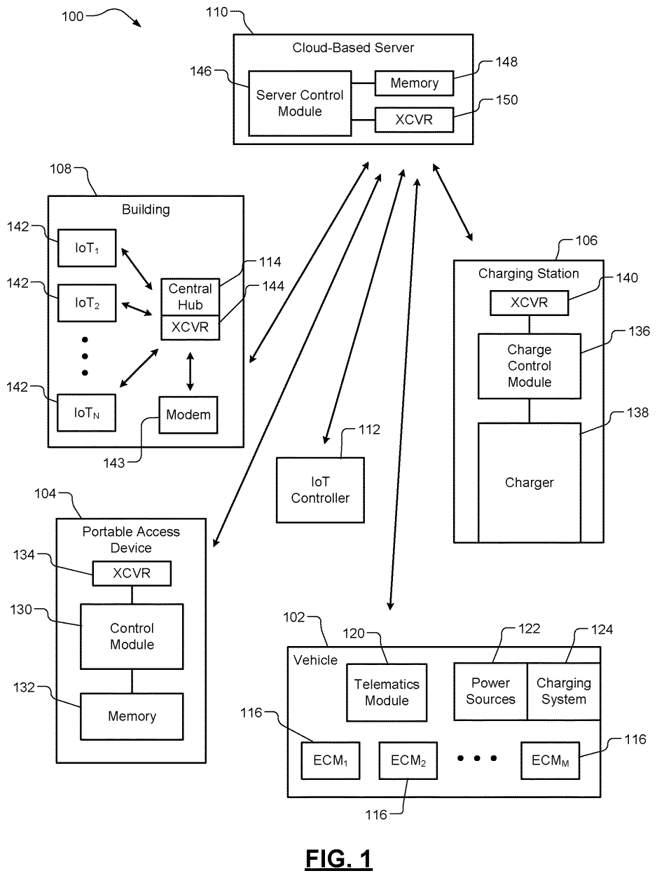

In an embodiment, the IoT controller determines how the allocated amount of the battery power budget is to be utilized. In another embodiment, each ECM determines how the allocated amount is to be utilized. For each feature being implemented, the IoT controller or the corresponding ECM determines how the allocated amount is to be utilized. As used herein, the term “feature” may refer to a device, component and/or technology element that contributes to vehicle functionality, vehicle safety, and/or user experiences with the vehicle. A function may refer to operational and performance capabilities of a given feature that the vehicle implements for the user. As used herein, an attribute may refer to a parameter used by, calculated by, and/or output from a particular function. An example of a feature is an emergency call made by the vehicle to a cloud-based server due to a collision that occurred with the vehicle. This feature is implemented by multiple ECMs of the vehicle. The ECMs function to collect data and then make a call to the cloud-based server to upload the data. As another example, a feature may refer to a security monitoring mode while the vehicle is in the OFF state. A vehicle may perform many features that require connectivity such as checking a vehicle charge status, remotely communicating with the vehicle to turn ON, starting a heater, locking a door, closing a window, turning ON or OFF lights, etc. These features may be triggered by for example, a central hub (example of which shown in FIG. 1), a portable access device, the vehicle, a charging station, or other device.

The examples disclosed herein include a method of dynamically allocating, monitoring, increasing, and limiting assigned battery power budgets per each ECM of a vehicle based on contextual data that is not traditionally available to a vehicle. A battery power budget for an ECM may refer to the amount of charge of one or more batteries and/or battery packs that may be used by the ECM while the vehicle is OFF and in the connectivity mode. The examples enable additional features on a vehicle to be implemented while the vehicle is OFF and while still meeting a minimum number of day requirements for the vehicle to remain OFF and be in the connectivity mode without batteries of the vehicle being recharged. A vehicle with an internal combustion engine may have a first number of required days (e.g., 14 days) to be able to remain OFF and in the connectivity mode, whereas an electric vehicle (EV) may have a second number of required days (e.g., 40 days) to be able to remain OFF and in the connectivity mode. After the required number of days, connectivity and/or ability to perform certain functions may cease if one or more the batteries of the vehicle are not charged. The number of required days is based on the maximum charge capacity of the vehicle, whether the vehicle has high-voltage battery pack(s) (e.g., battery packs operating at voltages of 100-800V) or simply a low-voltage battery (e.g., a 12V or 48V battery). A vehicle with a higher maximum charge capacity typically has higher day requirement. Battery budget management and allocation of a battery budget per ECM is based on pre-estimated needs of each ECM and battery state of charge. The above referred to contextual data may be associated with a time frame of less than the minimum number of day requirement for the vehicle to remain OFF and be in the connectivity mode without batteries of the vehicle being recharged.

The examples allow a battery power budget assignment to be dynamically decided based on access to an increased amount of contextual data that is available to each IoT device, which is internal or external to a vehicle. IoT devices in a home environment have access to various information and controls for controlling devices. As an example, the information may include information and/or controls associated with an EV charger, an electronic calendar, and mobile devices (e.g., portable access device such as a mobile phone, a tablet, a wearable device (e.g., smart watch), etc.).

The battery power budget assignments and limits may be determined and implemented internally or externally to the vehicle. Centralized and decentralized approaches are disclosed. A battery power budget for an ECM or a function of an ECM may be provided as a power amount over a set period of time and/or in milliampere-hours (mAh). Minimum and maximum battery power budgets may be provided for each ECM and/or function performed by each ECM. As an example, a disclosed centralized approach includes an IoT controller that collects information from all relevant connected devices within an ecosystem and from vehicle ECMs. The IoT controller assigns a battery power budget for each vehicle ECM based on power needs of the devices of the vehicle in the ecosystem and the collected contextual data. The IoT controller ensures the continuation of operations performed during the OFF state. In an embodiment, the IoT controller enables and/or triggers charging, disables undesired functions, and limits power consumption of selected ones of the ECMs of the vehicle to allow selected features to continue consuming power and remain active. The IoT controller may override a central hub of a home or facility that, for example, disables and/or delays charging due to it being a time of day associated with peak power consumption. If the IoT controller determines that batteries of a vehicle need to be charged to remain in the connectivity mode and/or to be able to perform certain functions, then the IoT controller may override the central hub calling for charging to be disabled.

In an embodiment and if the IoT controller is external to the vehicle, the IoT controller designates one or more ECMs in the vehicle to report the power needs of other ECMs of the vehicle to the IoT controller. Along with the power needs of each ECM, the one or more ECMs can also indicate why the requested amount of power is needed and which features the requested amount of power will support. The stated reporting can be done periodically or when certain conditions are satisfied. In an embodiment, the IoT controller configures a reporting frequency from ECMs to further conserve on battery consumption. The sooner an event will occur, the more frequent (or the higher the frequency) of the reporting.

As an example, a disclosed decentralized approach includes an IOT controller and ECMs making battery power budget determinations. These determinations are not performed by a single controller as with the centralized approach. The ECMs of the vehicle or a subset of the ECMs make some battery power budgeting decisions on their own (i.e., without instructions from another ECM or IoT controller). In an embodiment, an ECM decides based on internal logic to manage its battery power budget when contextual data is shared with the ECM and/or when the ECM determines that more power should be reserved for higher priority functions performed by the ECM. The IoT controller can share contextual data with ECMs to help aid the decision-making process performed internal to the ECMs. For example, IoT controller can share with the ECMs that a charger is plugged in and can be turned on if a battery level is low. As another example, the IoT controller can share a driver's schedule or a time of a next scheduled trip. This information can be used by vehicle ECMs to manage their own battery budget consumption.

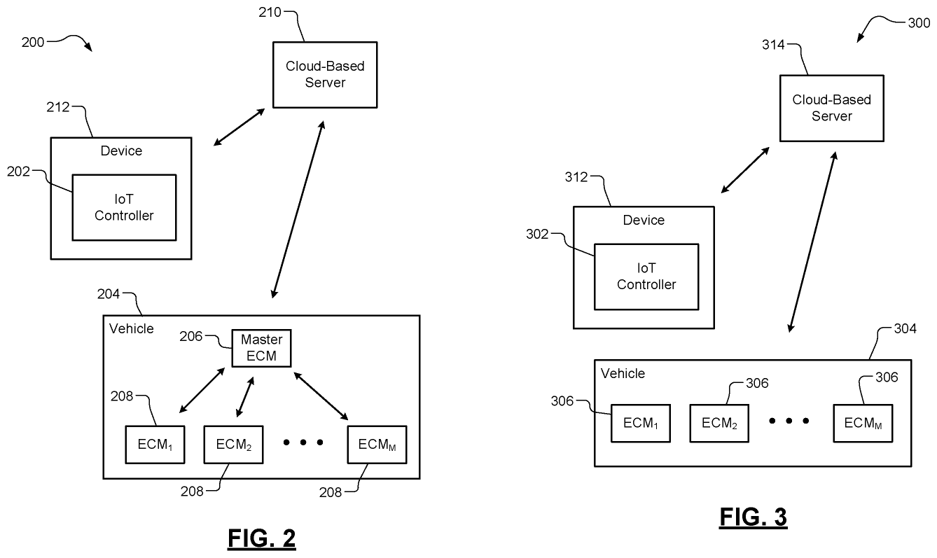

FIG. 1 shows an IoT ecosystem 100 including a vehicle 102, a portable access device 104, a charging station 106, a building 108, and a cloud-based server 110 and an IoT controller 112. The IoT controller 112 may be implemented in the vehicle 102, the portable access device 104, the charging station 106, the building 108, a central hub 114 of the building, or elsewhere. When implemented in the vehicle, the IoT controller may be implemented separate from the telematics module 120 and may be separate from or implemented as one of the ECMs 116. When implemented in the portable access device 104, the IoT controller may be separate from or integrated as part of the control module 130. When implemented in the charging station 106, the IoT controller may be separate from or integrated as part of the charge control module 136. When implemented in the building, the IoT controller may be implemented as part of the central hub 114. The IoT controller performs the above-stated operations and other operations disclosed below for management of battery power budgets, which may include setting battery power budget limits of ECMs 116 of the vehicle 102. Other example ECMs are referred to and described with respect to FIGS. 2-9. Other examples of vehicles that may be included in the IoT ecosystem are shown in FIGS. 2-5.

The vehicle 102 includes the ECMs 116, a telematics module 120, power sources 122, a charging system 124. The portable access device 104 may be a mobile phone, a tablet, a wearable device (e.g., a smart watch), a key fob, etc. and includes a control module 130, a memory 132, and a transceiver 134. The charging station 106 includes a charge control module 136, a charger 138, and a transceiver 140. The building 108 includes the central hub 114, IoT devices 142, a modem 143 (e.g., a wireless fidelity (Wi-Fi™) modem), and a transceiver 144. The building 108 may be a residential home, a commercial building, or other building. The cloud-based server 110 includes a server control module 146, memory 148 and a transceiver 150.

The IoT controller 112 may communicate with the vehicle 102, the portable access device 104, the charging station 106 and/or the building 108 via the cloud-based server 110 and/or via one or more other cloud-based servers and/or via a distributed network. The IoT controller 112 may communicate with the vehicle 102, the portable access device 104, the charging station 106 and/or the building 108 via the modem 143 and the cloud-based server 110. The stated communication may include transmission and reception of radio frequency (RF) signals, Wi-Fi™ signals, local area network (LAN) signals, Thread signals, Bluetooth® signals, Bluetooth®, Bluetooth Low Energy (BLE) signals, Ultra-Wideband (UWB) signals, etc. The use of Wi-Fi™ signals minimizes communication times between the IoT controller 112 and the vehicle 102, the portable access device 104, the charging station 106 and/or the building 108, which reduces power consumption associated with this communication. The Wi-Fi™ communication is quicker and cheaper than, for example, cellular communication. The stated communication allows the vehicle 102 to perform more operations while OFF and in the connectivity mode. When the IoT controller 112 is part of the vehicle, the IoT controller 112 may communicate with the modem 143 and/or with the transceiver 150 via the telematics module 120 and the cloud-based server 110. When the IoT controller 112 is implemented as part of the portable access device 104, the IoT controller 112 may communicate with the modem 143 and/or with the transceiver 150 via the transceiver 134 and the cloud-based server 110. When the IoT controller 112 is implemented as part of the charging station 106, the IoT controller 112 may communicate with the modem 143 and/or with the transceiver 150 via the transceiver 140 and the cloud-based server 110.

The charging station (or vehicle charger) may be installed in the building, on a wall of the building, or be a separate charging station proximate to the building. The central hub 114 may be a home (or residential) hub, a commercial building hub, or other central hub with a corresponding ecosystem including IoT devices 142. The IoT devices 142 may include speakers, Wi-Fi™ compatible devices, appliances (e.g., refrigerators, washers, dryers, ovens, etc.), lights, light bulbs, plugs, switches, buttons, etc. An IoT device refers to a device that can connect to the Internet and share data.

The IoT ecosystem 100 may implement protocols of home ecosystems such as protocols of an Amazon Alexa® ecosystem, an Apple HomeKit® ecosystem, and/or a Google Home® ecosystem. The central hub 114 and the IoT devices 142 may be configured to operate and communicate according to one of these ecosystems. The central hub 114 may be in communication with a cloud-based server associated with one of these ecosystems.

FIG. 2 shows a portion 200 of an IoT ecosystem including an IoT controller 202 implemented separate from a vehicle 204 and the vehicle 204 including a master electronic control module (ECM) 206 and secondary ECMs 208. The master ECU 206 is in communication with the IoT controller 202 via a cloud-based server 210. The IoT controller 202 may be implemented at a device 212, such as a central hub of a building, a portable access device, a charging station, etc. The IoT controller 202 may make battery power budget decisions and provide those decisions directly or indirectly to the master ECM 206. The master ECM 206 may then make battery power budget decisions relative to the ECMs 208. The master ECM 206 may generate battery power budgets for the ECMs 208. This may include battery power budgets for functions of each of the ECMs 208 or for each of some of the ECMs 208. One or more of the ECMs 208 may generate battery power budgets for functions of that one or more ECMs. In an embodiment, the master ECM 206 also operates as a telematics module. In another embodiment, the master ECM 206 also operates as a vehicle control module.

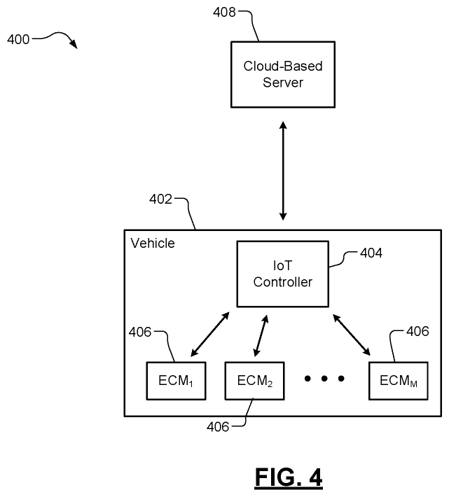

FIG. 3 shows a portion 300 of an IoT ecosystem including an IoT controller 302 separate from a vehicle 304 and the vehicle 304 including multiple ECMs 306. Although a master ECM is not shown in FIG. 3, the vehicle 304 may include a master ECM as shown in FIG. 2. The IoT controller 302 may be implemented at a device 312, such as a central hub of a building, a portable access device, a charging station, etc. The IoT controller 302 may make battery power budget decisions and provide those decisions to the ECMs 306 directly or indirectly via a cloud-based server 314. Each of the ECMs 306 may be assigned a respective battery power budget and either i) allocate portions of that battery power budget for functions implemented by that ECM based on allocations provided from the IoT controller 302, or ii) determine portions of that battery power budget to allocate respectively for the functions implemented by that ECM without receiving allocations from the IoT controller 302. The allocations may be determined based on an amount of time the ECM is OFF, when a next trip of the vehicle 304 is expected, when a next charge event is expected, etc. Thus, battery power budgets may be set and adjusted at the ECM level and at the function level.

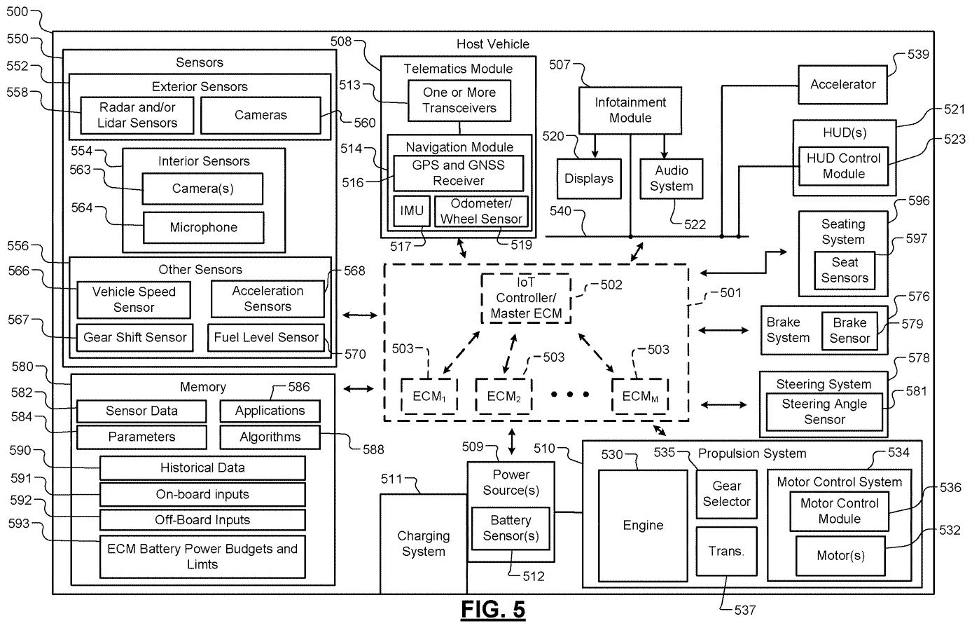

FIG. 4 shows a portion 400 of an IoT ecosystem including an example vehicle 402 with an IoT controller 404 and multiple ECMs 406. The IoT controller may communicate directly or indirectly with a cloud-based server 408.

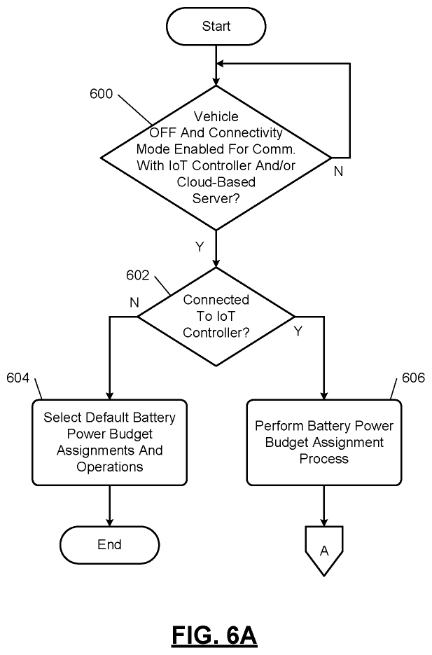

FIG. 5 shows a host vehicle 500 that includes a battery power management system 501, which may include an IoT controller or master ECM 502 and multiple other ECMs 503. The ECMs 503 may include a master ECM. Although shown as separate ECMs, the ECMs 503 may be implemented as part of the systems of the host vehicle 500, such as part of any of the systems referred to below and shown in FIG. 5. The IoT controller or master ECM 502 may operate the same or similarly as any of the IoT controllers and master ECMs referred to herein.

The host vehicle 500 may represent any of the vehicles 102, 204, 304, 402 of FIGS. 1-4. The vehicle 500 includes an infotainment module 507 and a telematics module 508, which may each be implemented as one of the ECMs 503. The ECMs 503 may be implemented as an access module, a vehicle control module, a brake control module, a steering control module, etc. The host vehicle 500 may be a partially or fully autonomous vehicle, a vehicle with assisted driving capabilities, or a non-autonomous vehicle.

The host vehicle 500 further includes one or more power sources 509 and a propulsion system 510. The vehicle control module may control operation of the host vehicle 500 including the propulsion system 510 and other system described below. The power sources 509 may include one or more batteries and/or battery packs, a generator, a converter, a control circuit, terminals for high and low voltage loads, etc., as well as one or more battery sensors 512 for detecting states of the power sources 509 including voltages, current levels, states of charge, etc. A charging system 511 may be included for charging the power sources 509. The charging system 511 may be plugged into a building charging station and/or charger, as referred to herein.

The telematics module 508 provides wireless communication services within the host vehicle 500 and wirelessly communicates with access secured devices, service providers, network devices (e.g., cloud-based network devices, central office devices, and/or back-office devices), other vehicles, mobile devices, infrastructure devices, and other devices external and/or internal to the host vehicle 500. The telematics module 508 may support Wi-Fi®, Bluetooth®, BLE, UWB, near-field communication (NFC), cellular, legacy (LG) transmission control protocol (TCP), long-term evolution (LTE), and/or other wireless communication and/or operate according to Wi-Fi®, Bluetooth®, BLE, UWB, NFC, cellular, and/or other wireless communication protocols. The telematics module 508 may include one or more transceivers 513 and a navigation module 514 with a global positioning system (GPS) and GNSS (or Global Navigation Satellite System) receiver 516. The navigation module 514 may include an inertial measurement unit (IMU) 517 and an odometer/wheel sensor 519. The transceivers 513 wirelessly communicate with network devices internal and external to the host vehicle 402 including cloud-based network devices, central stations, back-offices, and portable network devices. The transceivers 513 may perform pattern recognition, channel addressing, channel access control, and filtering operations.

The navigation module 514 executes a navigation application to provide navigation services. The navigation services may include location identification services to identify where the host vehicle 500 is located. The navigation services may also include guiding a driver and/or directing the host vehicle 500 to a selected location. The navigation module 514 may communicate with a central station to collect map information indicating levels of traffic, transportation object identification and locations (e.g., locations and types of signs), path information, weather information, etc. As an example, if the host vehicle 500 is an assisted and/or automated driving vehicle, the navigation module 514 may direct the vehicle control module 506 along a selected route to a selected destination. The GPS and GNSS receiver 516 may provide: location information; velocity and/or direction (or heading) of the host vehicle 500, other vehicles, and objects (e.g., pedestrians and cyclists); and/or global clock timing information.

One or more HUDs (also referred to as augmented reality (AR) HUDs) 521 are included and may include one or more HUD control module(s) (one HUD control module 523 is shown). The HUD control module 523 is in communication with the modules 506 and may display information regarding devices within a building and ecosystem such as states of access secured devices and IoT devices. This may include states of these devices (e.g., open, closed, locked, unlocked, on, off, etc.)

The infotainment module 507 may include and/or be connected to an audio system 522 and/or a video system including one or more displays. The displays 520, 521 and audio system 522 may be part of a human machine interface. The displays 520, 521 may include cluster and/or center console displays, etc. Haptic devices (e.g., steering wheel and/or seat vibration devices) may be used in addition to the displays 520, 521 and the audio system 522 to interact with a vehicle occupant such as a driver or passenger. This interaction is further described below. Messages may be displayed, audibly played out, and/or indicated via the displays 520, 521, the audio system 522, the haptic devices, and/or via one or more other output devices.

The infotainment module 507 may provide various information, the above-stated device information, warnings, and proactive messages including: status information; routing information; whether driving operations are autonomously controlled, limited and/or prevented; gear shifter status; upcoming and currently being performed operations (e.g., braking, accelerating, turning operations); detected objects (or obstacles); vehicle status information; diagnostic information; prognostic information; entertainment features and information; etc. The infotainment module 507 may be used to guide a vehicle operator to a certain location, indicate trip estimations (e.g., distances to selected destinations), and other information.

The propulsion system 510 may include one or more torque sources, such as one or more motors and/or one or more engines (e.g., internal combustion engines). In the example shown in FIG. 1, the host vehicle 500 includes an engine 530 and one or more motors 532. The torque sources are independently controlled. The propulsion system 510 includes a motor control system 534 that includes the one or more motors 532 and a motor control module 536 that may control operation of the one or more motors 532 based on signals from the vehicle control module. The propulsion system 510 may include a gear selector and/or shifter 535 for setting a gear of a transmission 537 and/or for setting a drive state of one or more of the torque sources. The gear selector and/or shifter 535 may be an electronic selector (e.g., one or more electrical switches), a mechanical and/or electrical shifter, or other selector and/or shifter. The propulsion system 510 may be controlled based on position of an accelerator 539 (e.g., an accelerator pedal, a throttle plate, etc.).

The ECMs 503 and modules 507, 508, 523 may communicate with each other directly or indirectly via one or more buses 540, such as a controller area network (CAN) bus and/or other suitable interface. The vehicle control module may control operation of vehicle modules, devices and systems based on feedback from sensors 550 and information and/or instructions received from a cloud-based network device.

The sensors 550 may include exterior sensors 552, interior sensors 554, and other sensors 556. The exterior sensors 552 may include radar and/or lidar sensors 558 and imaging and audio devices (e.g., visual spectrum cameras, long-wave infrared cameras, short-wave infrared cameras, ambient light sensors, and microphone or microphone array) 560. The exterior sensors 552 may be used to detect objects external to the host vehicle 500 and/or in a path of the host vehicle 500. The objects may include lane markings and objects, other vehicles, pedestrians, bicyclists, etc. The exterior sensors 552 may include sensors for determining location and/or range of the vehicle 500 relative to an object and/or device.

The interior sensors 554 may include one or more interior imaging sensors (e.g., cameras) 563, and a microphone or microphone array 564. The interior sensors 554 may be part of a driver monitoring system (DMS). The cameras 563 may be used to detect, track and/or monitor vehicle occupants including detecting locations of vehicle occupants in the vehicle, anatomical features (e.g., face, arms, hands, legs, etc.) of the vehicle occupants, head locations and/or eyes, etc. The interior sensors 554 may be used to detect gaze directions of a driver and/or vehicle occupants. The interior sensors 554 may include door sensors, seat belt sensors, seat sensors, etc. The door sensor may indicate whether a door is open or closed. The seat belt sensors may indicate whether seat belts are buckled. The seat sensor may include, for example, load sensors, strain gauges, and/or piezoresistive or piezoelectric sensors for detecting whether an occupant is in a particular seat and the weight of the occupant.

The other sensors 556 may include a gear selector and/or shifter sensor 567, a vehicle speed sensor 566, acceleration sensors (e.g., longitudinal and lateral acceleration sensors) 568, and a fuel level sensor 570, as shown, and other sensors. Additional sensors may also be included such as brake system sensors (a brake sensor 579 is shown) and steering system sensors (a steering angle sensor 581 is shown). The gear selector and/or shifter sensor 567 generates a signal indicative of a state of the gear selector and/or shifter 535.

The vehicle control module may also include a mode selection module and a parameter adjustment module. The parameter adjustment module may be used to adjust parameters of the host vehicle 500. The vehicle control module may perform autonomous operations based on interaction with a vehicle occupant. As an example, the vehicle control module may operate in a fully or partially autonomous mode and may control the propulsion system 510, a brake system 576, and a steering system 578. In an embodiment, the vehicle control module controls operation of the systems 510, 576 and 578 based on or without interactions with a vehicle occupant. The vehicle control module may i) perform autonomous operations such as steering, braking, accelerating, etc., and/or ii) display and/or audibly playout messages, perform haptic operations via haptic devices, and/or output messages and/or corresponding signals via other output devices.

The host vehicle 500 may further include the memory 580. The memory 580 may store sensor data 582, parameters 584, applications 586, algorithms 588, historical data 590, on-board inputs 591, off-board inputs 592 from other devices external to the host vehicle 500 and ECM battery power budgets and limits 593. The sensor data and parameters may include access secured device locations, mobile access device locations, host vehicle locations, occupant locations, occupant weights, occupant heart rates, host and other vehicle locations, vehicle speed, vehicle acceleration, battery state of charge, fuel level, etc. applications 586. The applications 586 may include applications executed by the modules 507, 508 and the ECMs 503. An ECM battery power budget and one or more limits may be stored for each of the ECMs 503. The ECM battery power budget and one or more limits may be for a set period of time. If the ECM battery power budget is utilized in the set period of time, then functionality of that ECM may be limited or stopped until reallocation of additional power for the ECM and/or assignment of a new ECM battery power budget for the ECM.

Although the memory 580 and the vehicle control module are shown as separate devices, the memory 580 and the vehicle control module may be implemented as a single device. The memory 580 may also store historical data 590 and other data such as driver driving patterns, driver fueling patterns, driver stopping patterns, typical work schedule, typical travel schedule, upcoming events, other driver patterns, data collected by and/or generated by at least one of the modules 507, 508 and ECMs 503, traffic data, navigation data, map data, GPS/GNSS data, path data, speed data, and acceleration data, etc.

The vehicle control module may control operation of the propulsion system 510, the video system including the display 520, 521, the audio system 522, the haptic devices, the brake system 576, the steering system 578, a seating system 596, and/or other devices and systems according to parameters set by the modules 507, 508 and ECMs 503. The seating system 596 may include seat sensors 597 for detecting presence of an occupant and/or change in occupants, for example, change in a driver. The vehicle control module 506 may set at least some of the parameters based on signals received from the sensors 550.

The vehicle control module 506 may receive power from the power sources 509, which may be provided to the propulsion system 510, the brake system 576, the steering system 578, the seating system 596, etc. Power supplied to the haptic devices, the motors 532, the brake system 576, the steering system 578, the seating system 596, and/or actuators thereof may be controlled by the vehicle control module to, for example, adjust: motor speed, torque, and/or acceleration; braking pressure; steering wheel angle; pedal position; state of haptic devices; etc. This control may be based on the outputs of the sensors 550, the navigation module 514, the GPS and GNSS receiver 516, the data and information received from external devices, and the data and information stored in the memory 580.

The vehicle control module 506 may determine various parameters including a vehicle speed, a motor speed, a gear state, an accelerator position, a brake pedal position, an amount of regenerative (charge) power, an amount of auto start/stop discharge power, and/or other information. The vehicle control module may control operations of the systems 510, 576, 578 based on the stated parameters. The vehicle control module may display vehicle status information based on the stated parameters.

The host vehicle 500 can include various systems for assisting a driver, for performing autonomous operations, and/or for indicating to a vehicle occupant information regarding an environment of the host vehicle. For example, a host system may include a navigation system that provides map information indicating lane boundaries, street locations, speed limits, geographical locations of selected destinations, etc. The host system may provide the driver with instructions for driving to a selected destination and/or may perform autonomous operations such as braking, steering, and accelerating operations to drive the vehicle to the destination based on the map information.

As another example, the host vehicle 500 may include object detection and collision warning systems for detecting impending objects and performing countermeasures and/or taking evasive action to prevent a collision. The vehicle control module determines locations of the objects relative to the host vehicle 500 and trajectories of the objects and the host vehicle 500. If it is determined that the host vehicle 500 is likely to collide with one of the objects, one or more warning signals may be generated to indicate to the driver and/or the object of concern of the potential collision. These warnings may be provided in addition to digital gateways and other information described herein. The vehicle control module 506 may also or alternatively perform one or more other countermeasures (e.g., apply brakes to decelerate the host vehicle, change a steering angle of the host vehicle, etc.) to prevent a collision.

In an embodiment, an IoT controller as referred to above in FIGS. 1-5, assigns and/or recommends a battery power budget for one or more ECMs of a vehicle. The one or more ECMs then accepts, rejects, changes and/or negotiates an updated battery power budget for the one or more ECMs. This negotiation can occur between two or more of the ECMs without involvement of the IoT controller through the exchange of signals to determine agreed upon battery power budgets for each of the ECMs. The one or more ECMs may request additional battery power than recommended by the IoT controller. The request for additional battery power may be i) provided to the IoT control, which can then determine whether to allocate additional battery power and send out one or more updated battery power budgets to the one or more ECMs, or may be provided to one or more other ECMs to start a negotiation between the ECMs. Battery power budget decisions for the ECMs may be made by: the IoT controller; an IoT device separate from a vehicle of the ECMs such as one of the IoT devise 142 of FIG. 1; a master ECM of the vehicle; or secondary ECMs of the vehicle. In an embodiment, one or more ECMs determine battery power budgets for that one or more ECMs independent of the IoT controller.

The following method may be implemented by the systems of FIGS. 1-5

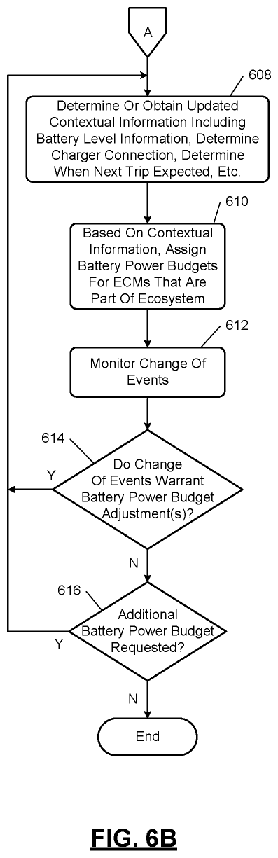

FIGS. 6A and 6B (collectively FIG. 6) shows a centralized method of battery power budget allocation for ECMs of a vehicle. During the centralized method, an IoT controller (e.g., one of the IoT controllers of FIGS. 1-5) may talk to one ECM. In an embodiment, the IoT controller talks to one ECM and then the one ECM makes battery power budget decisions for the other ECMs of the vehicle. The IoT controller may periodically receive contextual data updates at a predetermined frequency based on when the next vehicle traveling event is expected to occur. The shorter the time until the next vehicle traveling event, the more frequent the contextual updates. The following operations may be iteratively performed.

At 600, a first ECM of a host vehicle determines whether the host vehicle is OFF in the connectivity mode for communication with the IoT controller and/or cloud-based server. In an embodiment, the first ECM is a master ECM. If yes, operation 602 is performed.

At 602, the first ECM determines whether the telematics module of the host vehicle is connected to the IoT controller. If no, operation 604 is performed, otherwise operation 606 is performed.

At 604, the first ECM selects default battery power budget assignments, which may be stored in memory (e.g., the memory 580 of FIG. 5).

At 606, the first ECM performs battery power budget assignment process, which may include the following operations 608, 610, 612, 614, 616.

At 608, the IoT controller and/or the first ECM determines and/or obtains updated contextual information (or data) including battery level information, whether the vehicle is connected to a charger, information regarding when a next trip or traveling event for the vehicle is to occur, and/or other contextual information. In an embodiment, the IoT controller determines this information and shares it with the first ECM.

At 610, based on the contextual information, the IoT controller and/or the first ECM assigns battery power budgets for the ECMs of the vehicle that are part of an ecosystem of the IoT controller. In an embodiment, the IoT controller assigns the battery power budgets and provides the battery power budgets to the first ECM, which then shares the battery power budgets to the other ECMs. In another embodiment, the IoT controller determines an overall battery power budget for the vehicle and shares that with the first ECM, which then determines the battery power budgets for the first ECM and the other ECMs based on the overall battery power budget. Operation 610 may account for additional battery power budget requests received, as described below with respect to operation 616.

At 612, the IoT controller and/or the first ECM monitors for one or more changes in events such as changes in functions being performed, changes in state of charge of batteries of the vehicle, updates in contextual information, updates of when a next travel event or power on event of the vehicle is to occur, etc.

At 614, the IoT controller and/or the first ECM determines whether the one or more changes in events warrants battery power budget adjustments. If yes, operation 608 may be performed, otherwise operation 616 may be performed.

At 616, the IoT controller and/or the first ECM determines whether there are any additional battery power budget requests, such as a second one of the ECMs requesting additional power to continue performing a certain operation and/or a currently running process. If yes, operation 608 may be performed, otherwise the method may end. A request may be sent from the second one of the ECMs to the first ECM, which may then relay the request to the IoT controller or may determine updated budgets. This may include decreasing the budgets for one or more other ones of the ECMs to account for the addition power requested by the second one of the ECMs.

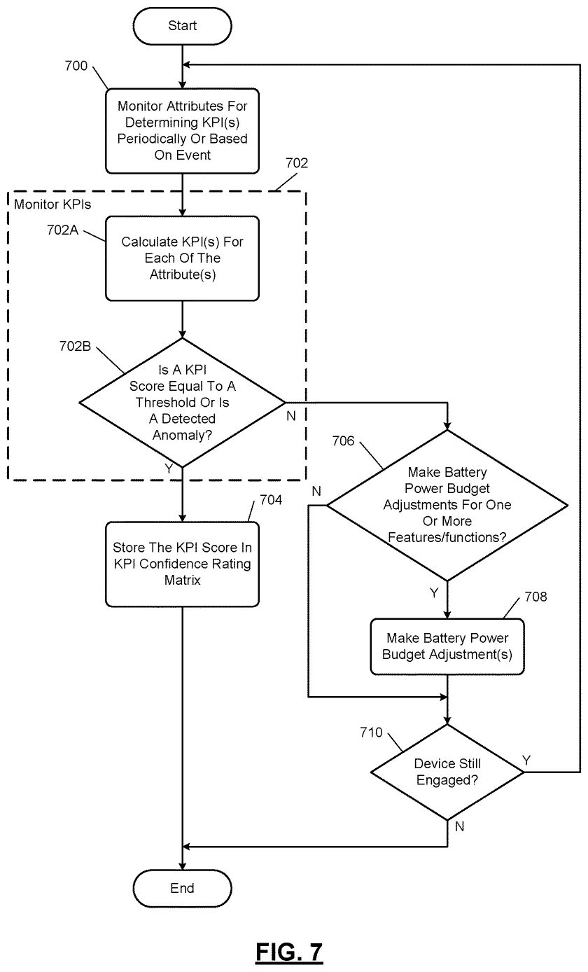

In an embodiment, the following FIGS. 7-9 are performed concurrently and/or sequentially.

FIG. 7 shows a decentralized method of battery power budget allocation. During the decentralized method, an IoT controller (e.g., one of the IoT controllers of FIGS. 1-5) may talk to multiple ECMs including providing battery power budgets respectively for the ECMs. Each of the ECMs may then make battery power budget decisions for functions performed by the ECM. Each ECM has its own algorithm to monitor itself and it knows the timing and operations performed and associated with functions, applications, and attributes of that ECM. Each ECM has its own key performance indicators (KPIs), knows its own degradation over last predetermined period of time, and is better able to allocate remaining portions of the ECM's battery power budget. This allocation may be based on received over the air updates. The over the air updates include contextual data. One example over the air update is an expected date when energy allocated to the ECM is expected to be drained. Another example over the air update is an expected date of energy drain for the ECM. The following operations may be iteratively performed.

At 700, the IoT controller and/or ECMs monitor attributes for determining key performance indicators (KPIs) periodically or based on one or more events.

At 702, the IoT controller and/or ECMs monitor KPIs. ECMs may connect and communicate with IoT controller and share over the air updates, compare KPIs with maximum, target, and/or expected KPIs, and in following operations make adjustments when appropriate. At 702A, the IoT controller and/or ECMs calculate KPIs for each of the attribute(s). At 702B, the IoT controller and/or ECMs determine whether one of the KPI scores is equal to a threshold or is a detected anomaly. A detected anomaly refers to when a KPI score is outside a predetermined range of an expected KPI score. As an example, when a KPI score is more than ±5-10% of an expected KPI score, then an anomaly is detected. If Yes, operation 704 is performed, otherwise operation 706 is performed.

At 704, the IoT controller and/or ECMs store the score in a KPI confidence rating matrix, which may be stored on the vehicle, in a portable access device memory, a memory of a central hub, a memory of a charger, etc. The KPI confidence rating matrix is a table relating KPI scores to confidence values indicative of whether the KPI score is accurate. The KPI confidence rating matrix may be used to evaluate whether future KPI scores are accurate and/or should be used in determining whether to make battery power budget adjustments. The KPI confidence rating matrix may also be used to determine whether an ECM is capable of reliably preforming a particular application. ECMs have different energy consumption rates and may be suitable for certain applications.

At 706, the IoT controller and/or ECMs determine whether to make battery power budget adjustments for one or more features and/or functions of one or more ECMs. If Yes, operation 708 is performed, otherwise operation 710 is performed.

At 708, the IoT controller and/or ECMs make battery power budget adjustments. In an embodiment, the adjustments are made for the features, functions and/or ECMs that are expected to or are currently consuming the most power. In an embodiment, the adjustments are made for the features, functions, and/or ECMs expected to or are consuming a predetermined percentage of an overall battery power budget for the vehicle or for one or more of the ECMs. These adjustments include a redistribution of an available remaining battery power budget prior to a next expected charge event. The adjustments may be made based on priority levels of the features and functions. More battery power may be assigned to higher priority features and functions.

At 710, the IoT controller and/or ECMs may determine whether one or more ECMs are still engaged (i.e., ON, running and consuming power). When engaged an ECM may be referred to as a source ECM or a sink ECM. A source ECM consumes less power than expected and/or allotted. An ECM that is not consuming power but has been expected to consume power and/or was allotted a certain percentage of an overall battery power budget may be deemed a source ECM. A sink ECM consumes more power than expected and/or allotted. If one or more ECMs are still engaged, operation 700 may be performed, otherwise the method may end. In an embodiment, operation 708 is subsequently performed to adjust for which ECMs are source ECMs and which ECMs are sink ECMs.

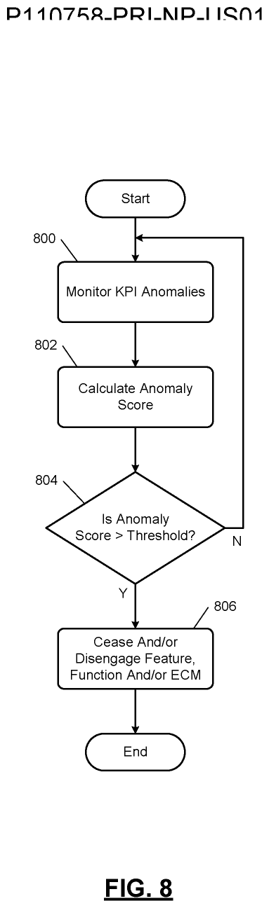

FIG. 8 shows a decentralized method for disengaging an ECM and/or one or more features and/or corresponding functions. The following operations 800, 802, 804 may be iteratively performed.

At 800, the IoT controller (e.g., one of the IoT controllers of FIGS. 1-5) and/or ECMs monitor KPI anomalies. The KPI anomalies may be monitored for features, functions and/or ECMs.

At 802, the IoT controller and/or ECMs calculate an anomaly score for each KPI. This includes calculating a numerical value ranging from 0 to 100, that quantifies how different a KPI value is from the expected KPI value, with a higher score indicating a greater anomaly.

At 804, the IoT controller and/or ECMs determine whether one or more of the anomaly scores is greater than a respective predetermined threshold (or limit). A different predetermined threshold may be assigned for each KPI anomaly. Two or more anomaly scores may be assigned a same predetermined threshold. If yes, the feature, function and/or ECM associated with the KPI score that is greater than the corresponding predetermined threshold is stopped and/or disengaged.

At 806, the IoT controller and/or ECMs cease and/or disengage the features, functions and/or ECMs with KPI anomalies that exceeded the corresponding predetermined thresholds. The method may end subsequent to operation 806 or may be repeated to continue monitoring other features, functions and/or ECMs that are still running and/or engaged.

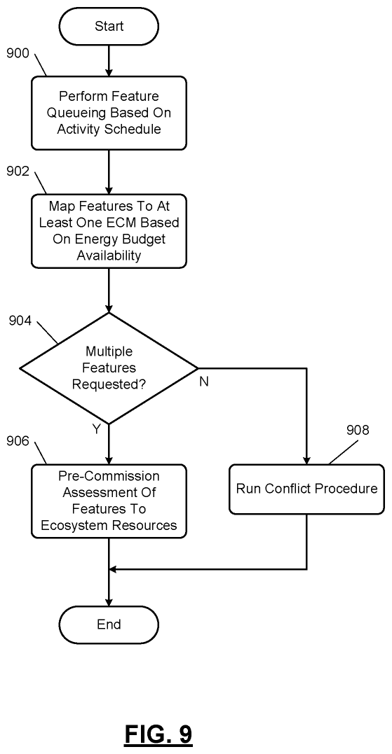

FIG. 9 shows a decentralized method for: mapping features to an ECM based on energy budget availability; pre-commissioning assessment of features; and addressing conflicts between features and/or ECMs of a vehicle. The following operations may be iteratively performed.

At 900, the IoT controller (e.g., one of the IoT controllers of FIGS. 1-5) and/or ECMs perform feature queueing based on an activity schedule. The queue stores identifiers of features and the order in which they are to be executed. Two or more features may be executed concurrently. The queue may be a first-in-first-out (FIFO) queue. In an embodiment, the queue is part of the memory 580 of FIG. 5. In another embodiment, the queue is part of the memory 132 or a memory of the central hub 114 or the charging station 106.

At 902, the IoT controller and/or ECMs map features to one or more ECMs based on energy budget availability (or battery power budget availability).

At 904, the IoT controller and/or ECMs determine whether there are multiple features being requested to be executed. If yes, operation 906 may be performed, otherwise operation 908 may be performed.

At 906, the IoT controller and/or ECMs perform pre-commissioning assessment of the features to ecosystem resources, which may run when the vehicle is OFF. This may include mapping the features to ecosystem resources including assigning the features to one or more ECMs and corresponding hardware to execute the features. Resource management may be implemented for functions (e.g., over the air updates) to be implemented by the one or more ECMs. The IoT controller may assign features to an ECM and the ECM may determine when to perform the features and the hardware involved in performing the features. The IoT controller may provide permissions to ECMs to allow the ECMs to make decisions regarding when and how long to carry out features and the power that can be consumed when carrying out the features. The ECMs may negotiate with the IoT controller the permissions.

At 908, the IoT controller and/or ECMs run a conflict procedure. This includes determining the order in which to perform the features and/or whether to perform more than one feature concurrently. This may be based on priority levels of the features, whether the features are non-emergency features or emergency features, etc. In an embodiment, the emergency features are executed prior to the non-emergency features. If multiple emergency features are requested, then execution of the features is based on priority and battery power availability. Similarly, if multiple non-emergency features are requested, then execution of the features is based on priority and battery power availability. The method may end subsequent to operations 906 and 908.

The above-described examples including using an IoT controller to dynamically allocate battery power budgets per ECM of a vehicle. The examples also include using an IoT controller to provide intelligence (or logic) to vehicle ECMs to change power internal consumption algorithms of the ECMs. The examples include feature-based battery power budget assignments. The ECMs can request additional battery power budgets from a network of devices and/or that were previously allocated to the network devices. The examples include creating a new operational mode for ECMs in an OFF state including creating battery power budgets for features and functions implemented by the ECMs. Battery power budget negotiation algorithms are used for negotiating battery power budgets between connected devices.

The above-described examples enable more feature to be implemented when a vehicle is OFF and increase number of days a vehicle can remain in a connectivity mode and be connected while OFF before needing to be charged. The examples further include a IOT controllers that aid ECMs to make better decisions regarding battery power budget assignments. The examples enhance user's IoT ecosystem experiences by providing additional features to be able to be implemented when a vehicle is OFF and connected to the IoT ecosystem. The examples ensure high priority feature operations are able to be performed when a vehicle is OFF and connected.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. An Internet-of-things (IoT) ecosystem comprising:
a plurality of electronic control modules (ECMs) implemented in a vehicle and configured to perform dedicated functions of features of the IoT ecosystem, wherein the IoT ecosystem includes a plurality of IoT devices; and
an IoT controller configured to obtain contextual data and, based on the contextual data, assign at least one battery power budget for the plurality of ECMs and corresponding ones of the dedicated functions, wherein at least a portion of the contextual data is received from the plurality of IoT devices and the plurality of ECMs, and
wherein
the plurality of ECMs are configured to implement the dedicated functions based on the at least one battery power budget, and
the at least one battery power budget i) refers to an amount of charge of one or more batteries of the vehicle that is available to be used by each of the plurality of ECMs and corresponding ones of the dedicated functions; and ii) includes a respective amount of power over a set period of time for each of the plurality of ECMs and corresponding ones of the dedicated functions.

2. The IoT ecosystem of claim 1, wherein the IoT controller is implemented in the vehicle, a portable access device, a charging station, a central hub of a building, or in an IoT device separate from the vehicle.

3. The IoT ecosystem of claim 1, wherein the IoT controller is configured to recommend a battery power budget for one of the plurality of ECMs, and receive from the one of the plurality of ECMs an accept or deny response for the recommended battery power budget from the IoT controller.

4. The IoT ecosystem of claim 3, wherein the one of the plurality of ECMs is configured to at least one of i) request additional battery power than recommended in the recommended battery power budget for the one of the plurality of ECMs, and ii) negotiate the battery power budget for the one of the plurality of ECMs with the other ones of the plurality of ECMs.

5. The IoT ecosystem of claim 1, wherein:
the IoT controller is configured to assign a battery power budget to one of the plurality of ECMs; and
the plurality of ECMs are configured to determine whether to accept or change the assigned battery power budget for the one of the plurality of ECMs.

6. The IoT ecosystem of claim 1, wherein:
the IoT controller is configured to implement battery power budget process including assigning an overall battery power budget for the plurality of ECMs of the vehicle and providing the overall battery power budget to one of the plurality of ECMs; and
the one of the plurality of ECMs is configured to determine battery power budgets for the remaining ones of the plurality of ECMs based on the overall battery power budget.

7. The IoT ecosystem of claim 1, wherein the IoT controller is configured to:
monitor for change of events with the plurality of ECMs;
determine whether the change of events warrant at least one of i) an updated overall battery power budget and ii) adjustment of one or more of the at least one battery power budget of the plurality of ECMs;
collect updated contextual data; and
in response to determining the updated overall battery power budget is warranted or adjustment of the one or more of the at least one battery power budget is warranted, collect updated contextual data, and based on the updated contextual data, update at least one of the updated overall battery power budget and the one or more of the at least one battery power budget.

8. The IoT ecosystem of claim 1, wherein the IoT controller or the plurality of ECMs is configured to:
monitor attributes of the dedicated functions for determining key performance indicators (KPIs);
calculate the KPIs for each of the attributes;
determine whether a KPI score is equal to a threshold or is a detected anomaly;
in response to the KPI score being equal to the threshold or being a detected anomaly, store the KPI score in a KPI confidence rating matrix;
in response to the KPI score not being equal to the threshold and not being an anomaly, determines whether to adjust one or more of the at least one battery power budget for one or more of the features and the dedicated functions; and
in response to determining to make the adjustment, adjust the one or more of the at least one battery power budget.

9. The IoT ecosystem of claim 1, wherein the IoT controller or the plurality of ECMs is configured to:
monitor key performance indicator (KPI) anomalies of attributes of the dedicated functions;
calculate anomaly scores;
determine if one of the anomaly scores is greater than a threshold; and
if greater than the threshold, at least one of i) cease performing at least one of the feature and the function associated with the one of the anomaly scores greater than a threshold, and ii) disengage one of the plurality of ECMs that is associated with the one of the anomaly scores greater than a threshold.

10. The IoT ecosystem of claim 1, wherein the IoT controller or the plurality of ECMs is configured to:
queue the features based on an activity schedule;
map the features to the plurality of ECMs based on the at least one battery power budget;
determine whether multiple features are requested;
if multiple features are requested, pre-commission assessment of features to ecosystem resources; and
run a conflict procedure to determine or of execution of the features requested.

11. The IoT ecosystem of claim 1, wherein at least some of the IoT devices are located in or attached to a building.

12. A method of allocating battery power for a plurality of electronic control modules (ECMs) of a vehicle in an Internet-of-things (IoT) ecosystem, the method comprising:
obtaining contextual data at an IoT controller and, based on the contextual data, assigning at least one battery power budget for the plurality of ECMs and corresponding ones of dedicated functions, wherein the dedicated functions are of features of the IoT ecosystem, and wherein at least a portion of the contextual data is received from a plurality of IoT devices in the IoT ecosystem and the plurality of ECMs; and
implementing the dedicated functions via the plurality of ECMs based on the at least one battery power budget,
wherein the at least one battery power budget i) refers to an amount of charge of one or more batteries of the vehicle that is available to be used by each of the plurality of ECMs and corresponding ones of the dedicated functions; and ii) includes a respective amount of power over a set period of time for each of the plurality of ECMs and corresponding ones of the dedicated functions.

13-14. (canceled)

15. The method of claim 12, further comprising:
via the IoT controller, assigning a battery power budget to one of the plurality of ECMs; and
via the plurality of ECMs, determining whether to accept or change the assigned battery power budget for the one of the plurality of ECMs.

16. The method of claim 12, further comprising:
implementing battery power budget process via the IoT controller including assigning an overall battery power budget for the vehicle and providing the overall battery power budget to one of the plurality of ECMs; and
determining, via the one of the plurality of ECMs, battery power budgets for the remaining ones of the plurality of ECMs based on the overall battery power budget.

17. The method of claim 12, further comprising:
monitoring for change of events with the plurality of ECMs;
determining whether the change of events warrant at least one of i) an updated overall battery power budget and ii) adjustment of one or more of the at least one battery power budget of the plurality of ECMs;
collecting updated contextual data;
in response to determining the updated overall battery power budget is warranted or adjustment of the one or more of the at least one battery power budget is warranted, collecting updated contextual data; and
based on the updated contextual data, updating at least one of the updated overall battery power budget and the one or more of the at least one battery power budget.

18. The method of claim 12, further comprising:
monitoring attributes of the dedicated functions for determining key performance indicators (KPIs);
calculating the KPIs for each of the attributes;
determining whether a KPI score is equal to a threshold or is a detected anomaly;
in response to the KPI score being equal to the threshold or being a detected anomaly, storing the KPI score in a KPI confidence rating matrix;
in response to the KPI score not being equal to the threshold and not being an anomaly, determining whether to adjust one or more of the at least one battery power budget for one or more of the features and the dedicated functions; and
in response to determining to make the adjustment, adjusting the one or more of the at least one battery power budget.

19. The method of claim 12, further comprising:
monitoring key performance indicator (KPI) anomalies of attributes of the dedicated functions;
calculating anomaly scores;
determining if one of the anomaly scores is greater than a threshold; and
if greater than the threshold, at least one of i) ceasing to perform at least one of the feature and the function associated with the one of the anomaly scores greater than a threshold, and ii) disengaging one of the plurality of ECMs that is associated with the one of the anomaly scores greater than a threshold.

20. The method of claim 12, further comprising:
queueing the features based on an activity schedule;
mapping the features to the plurality of ECMs based on the at least one battery power budget;
determining whether multiple features are requested;
if multiple features are requested, pre-commissioning assessment of features to ecosystem resources; and
running a conflict procedure to determine or of execution of the features requested.

21. The IoT ecosystem of claim 1, wherein the at least one battery power budget refers to an amount of charge of the one or more batteries of the vehicle that is available to be used by each of the plurality of ECMs and corresponding ones of the dedicated functions while the vehicle is OFF and in a connectivity mode.

22. The IoT ecosystem of claim 1, wherein the contextual data received at the IoT controller includes contextual data from each of the IoT devices and each of the ECMs.
